(19) United States
(12) Patent Application Publication
(10) Pub. No.: US 2026/0254744 A1
(43) Pub. Date: Aug. 27, 2026

(54) Counting Packets in Monitored Flows from Multiple Senders to a Single Receiver

(71) Applicant: Arista Networks, Inc., Santa Clara, CA (US)

(72) Inventors: Muhammad Khalid YOUSUF, San Jose, CA (US); Francois LABONTE, Menlo Park, CA (US); Stefan KHERAJ, Burnaby (CA)

(21) Appl. No.: 19/063,695

(22) Filed: Feb. 26, 2025

(51) Int. Cl. H04L 43/50; H04L 12/46

(52) U.S. Cl. CPC H04L 43/50; H04L 12/4641

(57) ABSTRACT

In a Distributed Scheduled Fabric (DSF), multiple sender leaf devices (senders) to send monitoring flows to a monitoring port on a receiver leaf device (receiver). The test packets from each flow include an identifier of the sender of the flow. A hardware engine in the egress pipeline associated with the monitoring port of the receiver increments a packet counter associated with the sender, thus providing and maintaining packet counts for each sender. The sender-specific packet counts can be provided to a monitoring agent that runs on the receiver for subsequent processing.

### BACKGROUND

The present disclosure is directed to a network architecture, commonly referred to as a distributed scheduled fabric (DSF), where data is forwarded across a network of switches called a fabric. The DSF comprises a cluster of devices referred to as leaf devices (nodes) and spine devices (fabric). The cluster of leaf devices are connected to each other via spine devices. Hosts connect to the leaf devices.

Traffic auditing provides an indication of the health of the fabric and the leaf devices. In traffic auditing, each leaf device generates and sends test packets to every other leaf device. Conversely, each leaf device receives test packets from every other leaf device. A leaf device counts the packets it receives from each of the other leaf devices. The information can be collected to identify problems in the fabric. Fabrics can have large numbers of leaf devices (e.g., on the order of many hundreds to thousands of leaf devices), and so completing the auditing process can take a long time.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 represents an example data network in accordance with the present disclosure.

FIGS. 2A and 2B illustrate example traffic flow in a distributed scheduled fabric.

FIG. 3 is a functional representation of components in an example network device in accordance with the present disclosure.

FIG. 4 shows example operations in a network device for processing test traffic in accordance with the present disclosure.

FIG. 5 is a representation of an example Ethernet frame.

FIG. 6 is a functional representation of example processing in an egress pipeline in accordance with the present disclosure.

FIG. 7 is a block diagram representation of an example network device.

### DETAILED DESCRIPTION

The present disclosure is directed generally to a distributed scheduled fabric (DSF), and in particular to auditing traffic in a DSF. The present disclosure provides high-speed processing in a receiving leaf device (receiver) of test traffic received from multiple sending leaf devices (senders). Each sender generates test traffic comprising test packets. Test packets from a sender include an identifier that uniquely identifies the sender. The receiver maintains a counter associated with each sender to count test packets received from a given sender. In order to accommodate large numbers of senders, each sending a high volume of test traffic, the counting is performed by the hardware of the egress pipeline in the receiver.

Packets sent to the receiver include a unique sender ID that identifies the sender. In some embodiments, for example, the test packets can be encoded as Ethernet 802.1q frames where the VLAN identifier encodes the sender ID. It will be appreciated that the sender ID can be incorporated in the test packets using techniques other than encoding the packets as VLAN packets.

In a DSF, packets sent from one leaf device (source) to another leaf device (destination) may be broken into smaller fragments called cells. The source distributes (sprays) the cells across the spine devices which then forward the cells to the destination. The destination device re-assembles the packets from the received cells. The test traffic can include large test packets in order to adequately stress the cell processing hardware in the sending and receiving leaf-devices and in the spine devices, including dis-assembly hardware in a sending leaf device and re-assembly hardware in a receiving leaf device.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

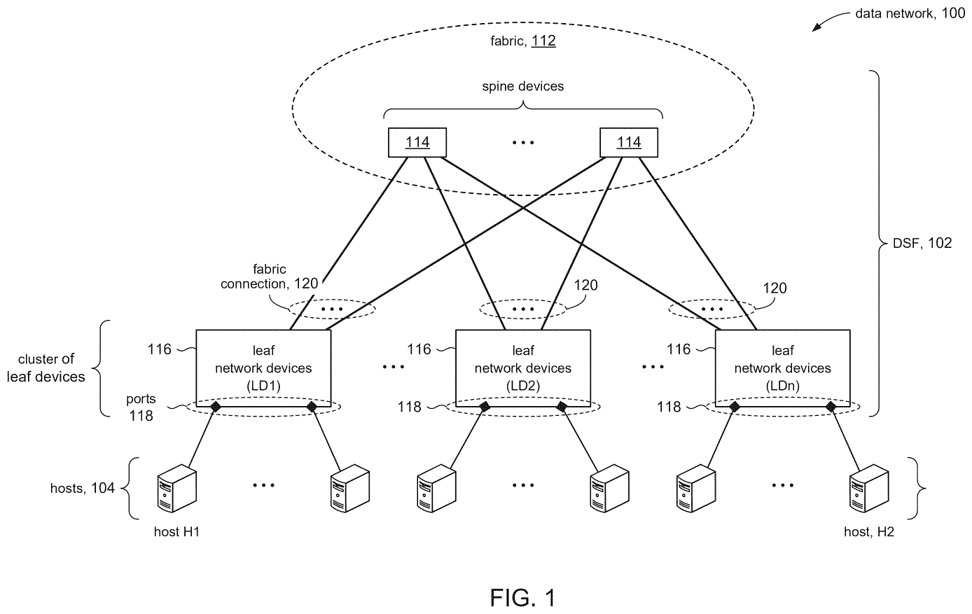

FIG. 1 is a high-level diagram illustrating a data network that can embody the techniques in accordance with the present disclosure. In some embodiments, for example, data network 100 comprises a distributed scheduled fabric (DSF) 102 to provide communication among hosts 104. It will be appreciated that a DSF can be based on any suitable network topology. DSF 102, for example, employs a network topology based on a spine-leaf architecture. DSF 102 includes a fabric 112 comprising spine devices (nodes) 114. A cluster of leaf network devices (leaf devices, nodes) 116 is interconnected by spine devices 114 via fabric connections 120. An example of a DSF is the 7700R4 Distributed Etherlink Switch™ (DES) switching system developed and sold by Arista Networks, Inc. of Santa Clara, California.

Hosts 104 connect to physical ports 118 on leaf devices 116; e.g., the example in FIG. 1 shows host H1 connected to an interface configured on a physical port 118 on leaf device LD1. Likewise, host H2 is connected to an interface configured on a physical port 118 on leaf device LD2. Each of the ports 118 among the leaf devices 116 in the cluster can be globally uniquely identified across the cluster of leaf devices.

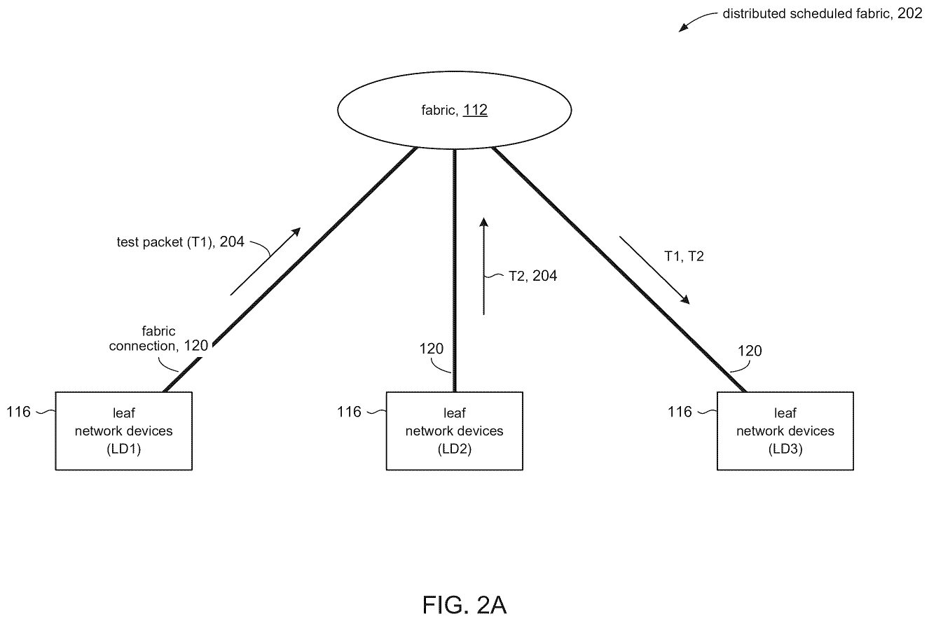

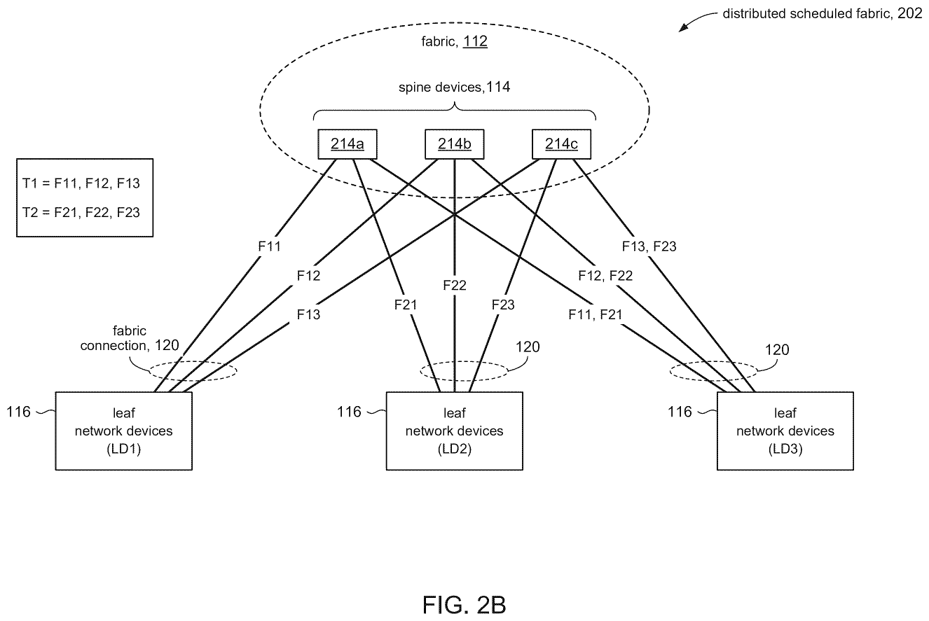

FIGS. 2A and 2B show an example of a distributed scheduled fabric (DSF) 202 to illustrate aspects of generating and processing of test traffic. FIG. 2A is a high-level diagram illustrating the generation and forwarding of test traffic. Each leaf device 116 (LD1, LD2, LD3) in DSF 202 can internally generate test traffic comprising test packets 204 and send its internally generated test traffic via fabric 112 to every other leaf device. Each leaf device 116 in turn can receive test traffic from the other leaf devices and maintain corresponding counts of packets in the test traffic received from the leaf devices. The example in FIG. 2A, for instance, shows leaf devices (e.g., LD1, LD2) transmitting test packets (e.g., T1, T2, respectively) to LD3 via fabric 112, and LD3 receiving packets T1, T2. Leaf device LD3 can maintain a packet counter of packets for each leaf device from which it receives test traffic. Although not shown in FIG. 2A, it will be understood that LD1 and LD3 send test traffic to LD2, and LD2 and LD3 send test traffic to LD1. The leaf devices are both senders of test traffic and receivers of test traffic.

Referring to FIG. 2B, in some embodiments, leaf devices 116 can fragment packets that are sent to fabric 112, and vice versa can re-assemble packet fragments received from the fabric. FIG. 2B shows that fabric connection 120 between each leaf device 116 and fabric 112 comprises individual connections between the leaf device and the constituent spine devices 114 of the fabric. For example, fabric connection 120 on LD1 comprises a fabric connection to spine device 214a, a fabric connection to spine device 214b, and a fabric connection to spine device 214c. When LD1 sends a packet, such as test packet 204 (T1) to fabric 112 for example, test packet T1 can be partitioned into fragments F11, F12, F13 and distributed to respective spine devices 214a, 214b, 214c. Conversely, when LD3 receives fragments F11, F12, F13 from the fabric, LD3 can re-assemble the fragments to recover test packet T1.

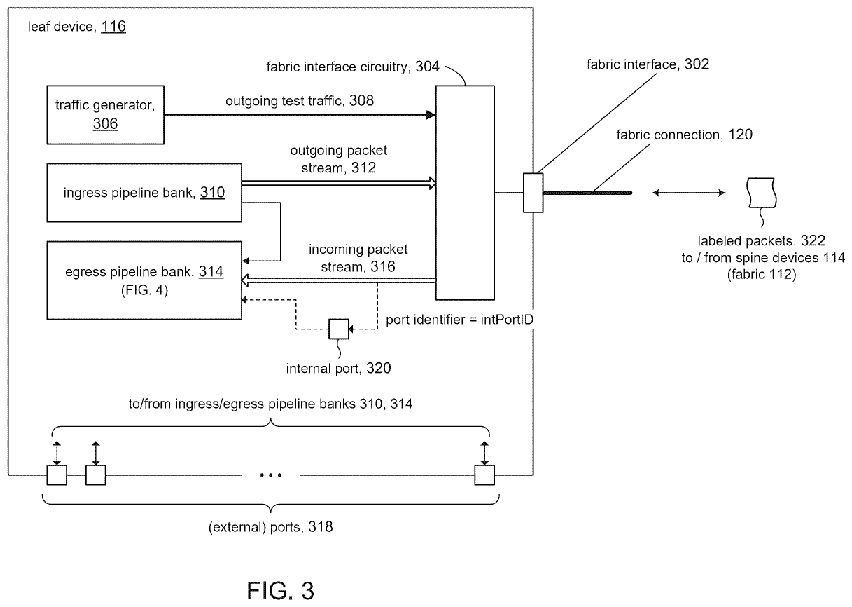

FIG. 3 is a functional representation of constituent hardware in leaf device 116 in accordance with some embodiments. For example, the hardware can include devices such as FPGAs (field programmable gate arrays), ASICs (application specific integrated circuits), and the like. Fabric connection 120 connects to leaf device 116 on fabric interface 302. Fabric interface circuitry 304 processes (1) traffic received from fabric 112 and (2) traffic to be sent to the fabric. For example, fabric interface circuitry 304 can fragment outgoing packets to be distributed among spine devices 114 in fabric 112. Conversely, fabric interface circuitry 304 can re-assemble incoming fragments received from the spine devices to recover their original packets. Traffic generator 306 can generate outgoing test traffic 308 and is discussed further below.

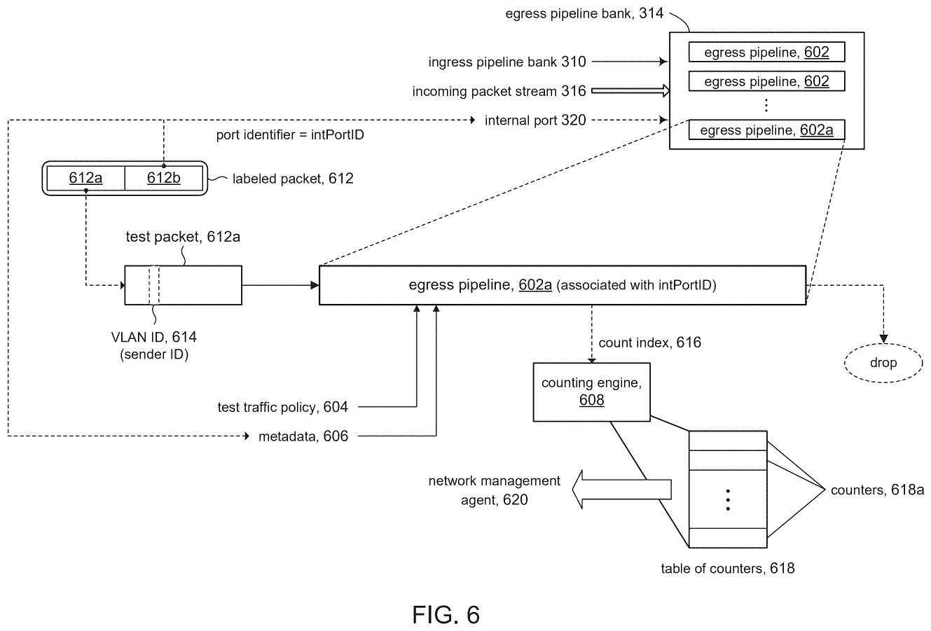

Leaf device 116 includes (external) ports 318 to which hosts (e.g., H1, FIG. 1) can connect. Leaf device 116 further includes one or more internal ports 320. Internal port 320 comprises internal circuitry that can be wired to egress pipeline bank 314. Fabric interface circuitry 304 can enqueue packets labeled for internal port 320 on one of the egress pipelines (602, FIG. 6) in egress pipeline bank 314. This aspect of the present disclosure is discussed in more detail below.

In some embodiments, ingress pipeline bank 310 comprises a plurality of ingress pipelines (not shown). Each ingress pipeline in bank 310 is associated with one or more ports 318 to process incoming traffic received on the associated port(s). Egress pipeline bank 314 comprises a plurality of egress pipelines (602, FIG. 6). Each egress pipeline in bank 314 is also associated with one or more ports 318 to process traffic for egress on the associated port(s).

Referring to FIGS. 1 and 3, processing host traffic received from a host connected to leaf device 116 generally proceeds as follows. Consider, for example, host traffic from host H1 connected to leaf device LD1:
The received host traffic is enqueued on a ingress pipeline in LD1 that is associated with the port on which the traffic ingressed or, in other words, the port to which H1 is connected.
When the traffic is destined for a host that is also connected to LD1, the ingress pipeline will forward the traffic to the egress pipeline in LD1 that is associated with the port to which the destination host is connected.
On the other hand, when the traffic is destined for a host (e.g., H2) that is connected on another (egress) leaf device (e.g., LDn), the ingress pipeline in LD1 will label the packet with a port identifier that uniquely identifies the port on the egress leaf device to which the destination host is connected, and send the labeled packet 322 to fabric 112 in outgoing packet stream 312.

Continuing with FIGS. 1 and 3, processing host traffic received from fabric 112 generally proceeds as follows. Consider, for example, leaf device LDn receiving host traffic from host H1:
The received host traffic comprises labeled packets 322 labeled with port identifiers that identify an egress port on LDn.
Fabric interface circuitry 304 in LDn uses the port identifier in the received packet to identify the egress pipeline in LDn that is associated with the egress port, and will enqueue the packet on the identified egress pipeline where the packet can be processed for egress on the identified port on LDn.

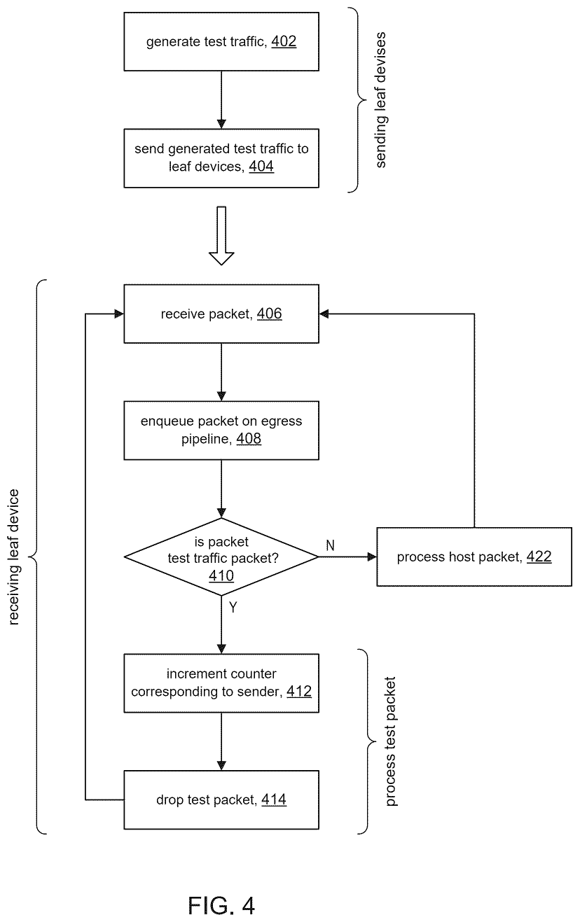

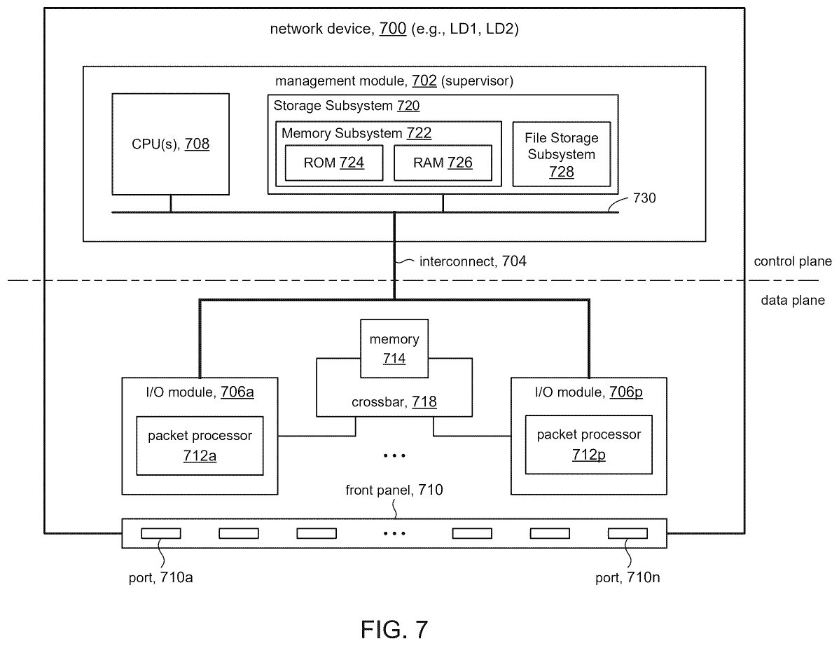

Referring to FIGS. 4, 5 and 6, the discussion will now turn to a high-level description of processing test traffic in a network device (e.g., 116, FIG. 3) to perform fabric auditing in a DSF in accordance with the present disclosure. The network device acts as a test traffic sender and as a test traffic receiver. The network device can include one or more processing units (circuits), which when operated, can cause the network device to perform processing in accordance with FIG. 4. Processing units (circuits) in the control plane, for example, can include general CPUs that operate by way of executing computer program code stored on a non-volatile computer readable storage medium (e.g., read-only memory); e.g., CPU 708 in the control plane (FIG. 7) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 712a-712p in the data plane (FIG. 7) can be a specialized processor.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

Leaf devices operate both as senders of test traffic and receivers of test traffic. The description of operations will begin with operations in a leaf device operating as a sender of test traffic.

### Sending Leaf Devices

The following operations can be performed in the control plane of the sending leaf device.

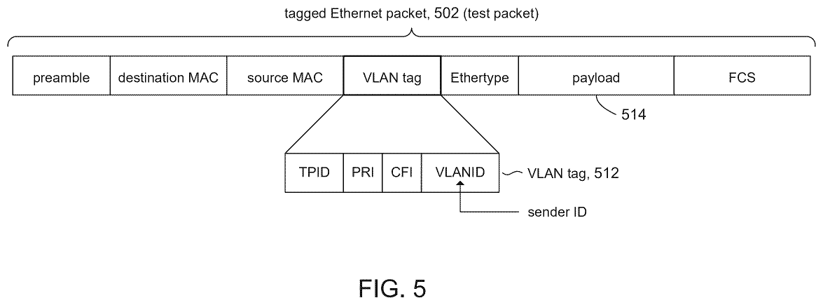

At operation 402, a sending leaf device can generate test packets. Referring to FIG. 3, in some embodiments for example leaf device 116 includes a traffic generator 306 that can generate test packets. The test packets include a sender ID that identifies the sending leaf device. In some embodiments, the test packets can be Ethernet frames that are VLAN tagged (virtual local area network). Referring for a moment to FIG. 5, the figures shows the general format for an Ethernet packet 502 tagged, for example, according to IEEE 802.1q. Tagged Ethernet packet 502 includes a VLAN tag 512 comprising various data fields including a TPID (Tag Protocol Identifier) and a VLAN ID (VLAN Identifier). The TPID identifies the type of VLAN tagging, and in accordance with the present disclosure can be set to 0x8100 to indicate 802.1q tagging. Further in accordance with the present disclosure, the sender ID of the sending leaf device can be stored in the VLAN ID data field of VLAN tag 512. While some embodiments use 802.1q tagged Ethernet frames to convey the sender ID, it will be appreciated that any suitable mechanism can be used to identify the sending leaf device in place of 802.1q tagging.

Recall from above, in some embodiments the labeled test packets may be fragmented into packet fragments (FIG. 2B) and distributed across the spine devices (e.g., 114) that constitute the fabric (e.g., 112). The fragmentation and re-assembly operations are performed in the fabric interface circuitry (e.g., 304) of the leaf devices. In accordance with the present disclosure, the traffic generator can generate test packets with large payloads 514 in order to test the fragmentation and re-assembly operations in the leaf devices and to test the processing (receipt and forwarding) of fragments in the spine devices. For example, the payload size can be expressed as:

$$payload size = n \times f ,$$

where f is the fragment size (e.g., expressed as a number of bits), and n is any real number >0.0; i.e., the payload size is not necessarily an integer number of fragments.

At operation 404, the sending leaf device can send the generated test packets to each of the other leaf devices in the DSF. In some embodiments, the test packets (e.g., 612a, FIG. 6) can be paired or otherwise labeled with a port identifier (e.g., 612b) that identifies the internal port (e.g., 320) on the receiving leaf device.

Operations 402 and 404 can be performed by each leaf device in the DSF concurrently and independently of each other. A receiving leaf device will receive multiple concurrent streams of test traffic from multiple sending leaf devices. The discussion will now turn to a description of operations in a leaf device operating as a receiver of test traffic.

### Receiving Leaf Device

The following operations can be performed in the data plane of the receiving leaf device.

At operation 406, a receiving leaf device can receive a labeled packet on its fabric interface (e.g., 322, 302). As explained above, the packets may be fragmented, in which case the fabric interface circuitry (e.g., 304) can re-assemble the packet fragments to recover the labeled packet.

At operation 408, the leaf device can identify the egress pipeline on which to enqueue the received packet for processing. The leaf device can use the port identifier that is paired with the packet to identify a corresponding egress pipeline. Referring to FIG. 3, for example, fabric interface circuitry 304 can use the port identifier to identify a corresponding egress pipeline in egress pipeline bank 314 on which to enqueue the packet.

At decision point 410, in the identified egress pipeline, if the received packet is not a test packet, then the egress pipeline can process the packet at operation 422 as a host packet; i.e., a packet that was sent from one host (source) to another host (destination). On the other hand, if the received packet is a test packet, then processing in the egress pipeline can proceed to operation 412 to process a test packet.

Referring for a moment to FIGS. 3 and 6, an example illustrates the receipt and processing of a test packet in accordance with the present disclosure. The figures shows an example of egress pipeline bank 314 comprising egress pipelines 602, comprising hardware such FPGA, ASIC, and the like, to process packets enqueued on the pipeline for egress.

The figure shows labeled test packet 612 comprising test packet 612a paired with port identifier 612b. Port identifier 612b contains the value intPortID which specifies internal port 320. Internal port 320 in turn is associated with or otherwise maps to egress pipeline 602a and so test packet 612a is enqueued on egress pipeline 602a.

In some embodiments, egress pipeline 602a can determine that packet 612a is a test packet based on the port identifier 612b paired with the packet. For example, port identifier 612b can be provided to egress pipeline 602a as metadata 606. The packet can be destined to a physical (front panel) port or an internal port. If the packet is destined for an internal port, the packet can be deemed to be a test packet. In some embodiments, for example, all test traffic from sending leaf devices can send their test traffic to port identifier intPortID. Test traffic policy 604 can be programmed in the receiving leaf device to trigger on port identifier 612b being set to the value intPortID indicating that labeled packet 612 is destined for internal port 320 of the leaf device and treat the packet as a test packet.

Continuing with FIG. 4, at operation 412, the egress pipeline can increment a counter corresponding to the sender of the test packet. Referring to FIG. 6, for example, when test traffic policy 604 is triggered, this can trigger an operation in egress pipeline 602a to extract the value stored in the VLAN ID field 614 of test packet 612a.

Egress pipeline 602a can signal counting engine 608 to increment a counter 618a in a table of counters 618. Counter 618a is identified by count index 616, which the egress pipeline can set to the value of the extracted VLAN ID, or based on the value of the extracted VLAN ID. Because the VLAN ID is the sender ID of the sending leaf device, the counter 618a corresponds to the sending leaf device and the value of the counter represents the number of test packets received from the sending leaf device.

In some embodiments, counters 618a in the table of counters 618 can be read out by a network management agent 620 running on the leaf device and provided to a central controller (not shown). The information can be used to troubleshoot issues in the DSF.

At operation 414, the egress pipeline can drop the test packet. Processing of the received test packet can be deemed complete.

FIG. 7 is a schematic representation of a network device 700 (e.g., a router, switch, firewall, and the like) that can be adapted in accordance with the present disclosure. In some embodiments, for example, network device 700 can include one or more management modules 702, one or more I/O modules (switches, switch chips) 706a-706p, and a front panel 710 of I/O ports (physical interfaces, I/Fs) 710a-710n. Management module 702 can constitute the control plane of network device 700 (also referred to as the control layer or simply the central processing unit, CPU), and can include CPU(s) 708 for managing and controlling operation of network device 700 in accordance with the present disclosure. CPU(s) 708 can be a general-purpose processor, such as an Intel®/AMD® x86, ARM® microprocessor and the like, that operates under the control of software stored in a memory device/chips such as read-only memory (ROM) 724 or random-access memory (RAM) 726. The control plane provides services that include traffic management functions such as routing, security, load balancing, analysis, and the like.

CPU(s) 708 can communicate with storage subsystem 720 via bus subsystem 730. Other subsystems, such as a network interface subsystem (not shown in FIG. 7), may be on bus subsystem 730. Storage subsystem 720 can include memory subsystem 722 and file/disk storage subsystem 728. Memory subsystem 722 and file/disk storage subsystem 728 represent examples of non-transitory computer-readable storage devices that can store program code and/or data, which when executed by CPU(s) 708, can cause CPU(s) 708 to perform operations in accordance with embodiments of the present disclosure.

Memory subsystem 722 can include a number of memories such as main RAM 726 (e.g., static RAM, dynamic RAM, etc.) for storage of instructions and data during program execution, and ROM (read-only memory) 724 on which fixed instructions and data can be stored. File storage subsystem 728 can provide persistent (i.e., non-volatile) storage for program and data files, and can include storage technologies such as solid-state drive and/or other types of storage media known in the art.

CPU(s) 708 can run a network operating system stored in storage subsystem 720. A network operating system is a specialized operating system for network device 700. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 730 can provide a mechanism for the various components and subsystems of management module 702 to communicate with each other as intended. Although bus subsystem 730 is shown schematically as a single bus, alternative embodiments of the bus subsystem can utilize multiple buses.

The one or more I/O modules 706a-706p can be collectively referred to as the data plane of network device 700 (also referred to as the data layer, forwarding plane, etc.). Interconnect 704 represents interconnections between modules in the control plane and modules in the data plane. Interconnect 704 can be any suitable bus architecture such as Peripheral Component Interconnect Express (PCIe), System Management Bus (SMBus), Inter-Integrated Circuit (I²C), etc.

I/O modules 706a-706p can include respective packet processing hardware comprising packet processors 712a-712p (collectively 712) to provide packet processing and forwarding capability. Each I/O module 706a-706p can be further configured to communicate over one or more ports 710a-710n on the front panel 710 to receive and forward network traffic. Packet processors 712 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 712 can include forwarding lookup hardware such as, for example, but not limited to content addressable memory such as ternary CAMs (TCAMs) and auxiliary memory such as static RAM (SRAM).

Memory hardware 714 can include buffers used for queueing packets. I/O modules 706a-706p can access memory hardware 714 via crossbar 718. It is noted that in other embodiments, the memory hardware 714 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a first network device among a plurality of network devices, the method comprising the first network device:
receiving test packets from a plurality of second network devices among the plurality of network devices;
enqueueing the received test packets in an egress pipeline of the first network device; and
processing each of the received test packets in the egress pipeline of the first network device including, for each received test packet, the egress pipeline:
extracting a sender ID (identifier) contained in the test packet, wherein the sender ID corresponds to the network device, among the plurality of second network devices, that sent the test packet;
incrementing a value of a counter, among a plurality of counters, corresponding to the sender ID wherein the counter represents a number of test packets received from the corresponding network device; and
dropping the test packet.

2. The method of claim 1, wherein the test packets from the plurality of second network devices are received on an internal port on the first network device, wherein the egress pipeline is associated with the internal port.

3. The method of claim 2, wherein the internal port on the first network device receives traffic only from the plurality of second network devices.

4. The method of claim 1, wherein each of the plurality of second network devices comprises a packet generator that generates the test packets and transmits the generated test packets to the first network device.

5. The method of claim 4, wherein each of the plurality of second network devices sends the generated test packets to a fabric and the fabric sends the generated test packets to the first network device.

6. The method of claim 1, wherein the test packets sent by the plurality of second network devices are partitioned into packet fragments, wherein receiving the test packets from the plurality of second network devices comprises the first network device:
receiving the packet fragments; and
combining the packet fragments to reconstitute the test packets.

7. The method of claim 1, wherein the test packet is a VLAN (virtual local area network) packet and the sender ID is used as a VLAN ID in the VLAN packet.

8. The method of claim 1, further comprising:
the egress pipeline receiving a signal from a network management agent running in the first network device; and
in response to the egress pipeline receiving the signal, sending values of the plurality of counters to the network management agent.

9. The method of claim 1, wherein the plurality of network devices are configured in a spine-leaf architecture.

10. A first network device among a plurality of network devices, the first network device comprising:
one or more computer processors; and
a computer-readable storage device comprising instructions for controlling the one or more computer processors to:
receive test packets from a plurality of second network devices among the plurality of network devices;
enqueue the received test packets in an egress pipeline of the first network device; and
process each of the received test packets in the egress pipeline of the first network device including, for each received test packet, the egress pipeline:
extracting a sender ID contained in the test packet, wherein the sender ID corresponds to the network device, among the plurality of second network devices, that sent the test packet;
incrementing a counter, among a plurality of counters, corresponding to the sender ID wherein the counter represents a number of test packets received from the corresponding network device; and
dropping the test packet.

11. The first network device of claim 10, wherein the test packets from the plurality of second network devices are received on an internal port on the first network device, wherein the egress pipeline is associated with the internal port.

12. The first network device of claim 11, wherein the internal port on the first network device receives traffic only from the plurality of second network devices.

13. The first network device of claim 10, wherein each of the plurality of second network devices comprises a packet generator that generates the test packets and transmits the generated test packets to the first network device.

14. The first network device of claim 10, wherein the test packets sent by the plurality of second network devices are partitioned into packet fragments, wherein receiving the test packets from the plurality of second network devices comprises the first network device:
receiving the packet fragments; and
combining the packet fragments to reconstitute the test packets.

15. The first network device of claim 10, wherein the test packet is a VLAN (virtual local area network) packet and the sender ID is used as a VLAN ID in the VLAN packet.

16. A non-transitory computer-readable storage device in a network device, the non-transitory computer-readable storage device having stored thereon computer executable instructions, which when executed, cause the network device to:
receive test packets from a plurality of second network devices among the plurality of network devices;
enqueue the received test packets in an egress pipeline of the first network device; and
process each of the received test packets in the egress pipeline of the first network device including, for each received test packet, the egress pipeline:
extracting a sender ID contained in the test packet, wherein the sender ID corresponds to the network device, among the plurality of second network devices, that sent the test packet;
incrementing a counter, among a plurality of counters, corresponding to the sender ID wherein the counter represents a number of test packets received from the corresponding network device; and
dropping the test packet.

17. The non-transitory computer-readable storage device of claim 16, wherein the test packets from the plurality of second network devices are received on an internal port on the first network device, wherein the egress pipeline is associated with the internal port.

18. The non-transitory computer-readable storage device of claim 17, wherein the internal port on the first network device receives traffic only from the plurality of second network devices.

19. The non-transitory computer-readable storage device of claim 16, wherein each of the plurality of second network devices comprises a packet generator that generates the test packets and transmits the generated test packets to the first network device.

20. The non-transitory computer-readable storage device of claim 16, wherein the test packet is a VLAN (virtual local area network) packet and the sender ID is used as a VLAN ID in the VLAN packet.
